(19) United States
(12) Patent Application Publication
(10) Pub. No.: US 2008/0109762 A1
(43) Pub. Date: May 8, 2008

(54) Visual document user interface system

(75) Inventors: Gurpal S. Hundal, Issaquah, WA (US); Stephen J. Butler, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/592,918

(22) Filed: Nov. 3, 2006

(51) Int. Cl. G06F 17/00; G06F 3/00

(52) U.S. Cl. 715/855

(57) ABSTRACT

Technologies and techniques for displaying a set of documents having associated attribute data in a generated, map-like geographic representation. Documents may be assigned positions within the geographic representation according to the associated attribute data. The geographic representation may include multiple display levels respectively having different levels of detail associated with the documents. When the different display levels are rendered, the documents may be represented by topographical elements, attribute data, and/or document content. Rendered portions of the geographic representation may be overlaid with graphics to identify interrelated documents and visually connect the interrelated documents on a display device, thereby enabling a user to readily view the relationships between the documents. In visually connecting the interrelated documents, a document review path may be defined for a user to utilize in reviewing the interrelated documents.

### BACKGROUND

Reference libraries generally comprise collections, or sets, of reference materials that are utilized by persons to obtain information, knowledge, or insight related to a subject or topic of interest. For example, a reference library related to a computer operating system might comprise one or more sets of reference materials related to particular operating system features, including computer software source and/or object code, technical documentation, user documentation, and other materials. A computer software developer attempting to integrate a new capability into the computer operating system might access such a reference library in order to review relevant computer software source code and technical documentation.

A large reference library may comprise one or more sets of hundreds, thousands or, potentially, millions of individual reference materials in the form of, but not limited to, computer software source and/or object code, documents, books, manuals, periodicals, articles, drawings, diagrams, charts, maps, and other materials or items that include information in textual and/or graphical representations. Typically, the reference materials are cataloged or indexed to enable the location of desired materials by persons utilizing the reference library.

In recent years, the reference materials of many reference libraries and other sets of documents have been made electronically accessible to users via data communication networks. Unfortunately, catalogs, indexes, and tables of contents that are typically used with large reference libraries and sets of documents do not scale well for such electronic access. As a result, persons using such reference libraries and sets of documents are often presented with lengthy lists of documents for their review while attempting to locate desired documents. Such review can be a daunting and extremely time-consuming task. As an alternative to the use of traditional catalogs, indexes, and tables of contents, electronic queries and/or searches may be performed to find desired reference documents. However, such queries and/or searches typically do not enable users to discover interrelationships between documents that might be found during the use of traditional catalogs, indexes, and tables of contents. Consequentially, potentially helpful documents may not be located by electronic queries and/or searches.

### SUMMARY

Described herein are implementations of various technologies and techniques for displaying a set of documents having associated attribute data. In accordance with one implementation, a geographic representation of the set of documents may be generated for display on a display device via a graphical user interface. The geographic representation generally comprises a virtual map of the set of documents. The geographic representation includes a coordinate system and the documents may be assigned positions at respective locations within the geographic representation relative to the coordinate system and according to the associated attribute data.

According to one implementation, the geographic representation may further include multiple display levels that correspond to different levels of information detail. On at least one display level, documents may be rendered using topographical elements and/or effects that may be selected based on the value of one or more attributes of the documents. Through such use of different topographical elements and/or effects, documents having certain values of an attribute may be readily distinguished from other documents having different values of the attribute. Documents may be represented on other display levels by their associated attribute data, by their content, or by other representations.

The generated geographic representation, in accordance with another implementation, may be overlaid on a display device with related information for the documents. The related information may identify interrelated documents and visually connect the interrelated documents, or representations thereof, with a document review route or path. The document review route may be utilized by a user to review the interrelated documents. The document review route may identify the interrelated documents in an order of relevance to a topic of interest to the user, thereby making the user's review of the documents more efficient. The related information may also include comments and other information concerning particular documents that may be input by a user or otherwise generated.

This Summary is provided to introduce a selection of concepts in a simplified form that are further described below in the Detailed Description. This Summary is not intended to identify key features or essential features of the claimed subject matter, nor is it intended for use in limiting the scope of the claimed subject matter in any manner, including, without limitation, to implementations that solve any or all noted or unnoted disadvantages or difficulties of prior art.

### DESCRIPTION OF THE DRAWINGS

FIG. 1 displays a block diagram view of an example of a visual document user interface system implementation and environment therefor.

FIG. 2 displays a schematic view of an example of a geographic representation of a set of documents.

FIG. 3 displays a schematic view of an example of a geographic representation of a set of documents showing a plurality of display levels thereof.

FIG. 4 displays a flowchart view of an example of a method for representing and presenting a set of documents and related information to a user.

FIG. 5 displays a flowchart view of an example of a method for generating a geographic representation of a set of documents.

FIG. 6 displays a flowchart view of an example of a method for rendering and displaying at least a portion of a geographic representation generated for a set of documents.

FIG. 7 displays a pictorial view of an example of a graphical user interface with a visible drop-down tool menu for displaying at least a portion of a geographical representation for a set of documents.

FIG. 8 displays a pictorial view of an example of a graphical user interface for displaying at least a portion of a geographical representation for a set of documents, showing a first display level.

FIG. 9 displays a pictorial view of an example of a graphical user interface for displaying at least a portion of a geographical representation for a set of documents, showing a second display level.

FIG. 10 displays a pictorial view of an example of a graphical user interface for displaying at least a portion of a geographical representation for a set of documents, showing a third display level.

FIG. 11 displays a flowchart view of a first example of a method for overlaying and displaying information related to documents of a geographic representation.

FIG. 12 displays a pictorial view of an example of a route of related documents produced by a first example of a method for overlaying and displaying information related to documents of a geographic representation.

FIG. 13 displays a flowchart view of a second example of a method for overlaying and displaying information related to documents of a geographic representation.

FIG. 14 displays a pictorial view of an example of related information produced by a second example of a method for overlaying and displaying information related to documents of a geographic representation.

### DETAILED DESCRIPTION

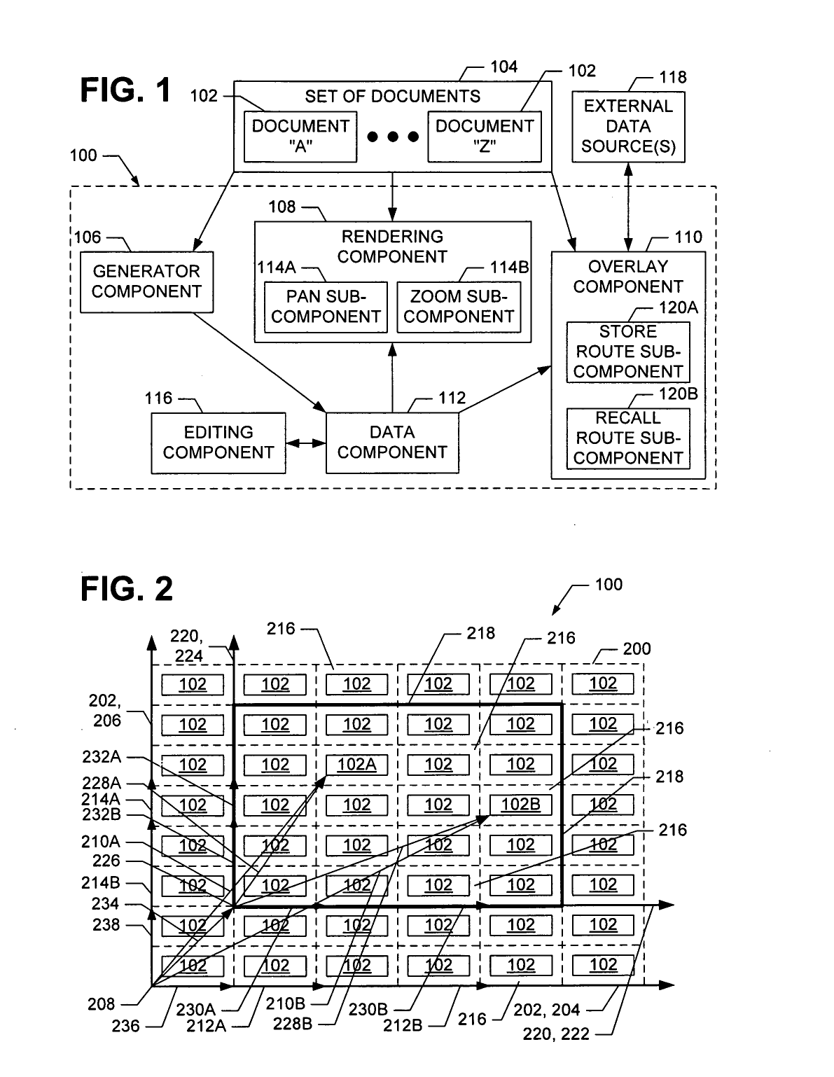

Referring now to the drawings in which like numerals represent like elements or steps throughout the views, FIG. 1 displays a block diagram view of an example of a visual document user interface system 100 implementation for representing documents 102 of a set of documents 104 as a geographic representation 200 (see FIG. 2) and for rendering and displaying the geographic representation 200 and related information on a display device. The geographic representation 200 generally comprises a virtual map in which documents 102 are assigned a spatially located position relative to a global coordinate system 202 (see FIG. 2). Portions of the geographic representation 200 are rendered for display based on a desired level of detail for the documents 102. Depending on the desired level of detail for display, the documents 102 may be represented at their respective spatially located positions, for example and not limitation, by topographical elements, by attribute information associated with the documents 102, or by the actual content of the documents 102.

Relationships between documents 102 may be determined and rendered as routes or paths. In addition to visually displaying relationships between documents 102, a route might include and identify other related documents 102 that might be of interest to a user and/or to other users. In a sense, the route might define a suggested reading path and/or sequence for a user to follow in reading or reviewing the identified documents 102 in order to gain information on a particular topic. As briefly described above, related information might also be rendered and displayed. Such related information may include the identities of and references, or links, to other documents that are not part of the set of documents 104 corresponding to the geographic representation 200. Additionally, such related information might include user comments or other user generated or provided information previously associated with documents 102.

The set of documents 104 comprises a portion of an environment with which the example visual document user interface system 100 (also sometimes referred to herein as the “system 100”) may be implemented. Generally, the set of documents 104 includes documents 102 in electronic form that reside on and are accessible from a data storage device, that are related to each other in some manner, and that may have one or more associated attributes and attribute data. In FIG. 1, individual documents 102 are denoted with alphabetic letters “A” through “Z”. Ellipses are present between the documents 102 of FIG. 1 to indicate that some of the documents 102 are not shown so as to enhance the clarity of illustration.

In one example of an environment utilized herein for purposes of illustration, the set of documents 104 may include a plurality of patent application documents 102 and issued patent documents 102 that are related in that they pertain to inventions created by employees and/or independent contractors of a company. Each patent application document 102 and issued patent document 102 may have attributes, including, but not limited to, an application or serial number, a title, a filing date, a name(s) of an inventor(s), a publication date, a publication number, and an assignee.

In another example of an environment with which system 100 may be implemented, the set of documents 104 may include computer software documentation documents 102 that are related to a particular computer software application. Each document 102 in the set of documents 104 may, perhaps, describe the structure of, operation of, and/or interfacing with a portion of the computer software application. Each document 102 may also include source code for such portion of the computer software application. Attributes associated with each computer software documentation document 102 may include, without limitation, a title, a version number, an author's name(s), a creation date, a modification date(s), a name of a code portion to which the document pertains, and a class to which such code portion belongs.

In still another example of an environment with which system 100 may be implemented, the set of documents 104 may include a plurality of three-dimensional model documents 102 of parts of an automotive vehicle that when taken or displayed together define the vehicle. Attributes associated with each model document 102 may include, for example and not limitation, a part number, a subsystem or subassembly designation to which the part belongs, a color code, a material type, a version number, references to drawings that illustrate the part from different views, and an identifier for another vehicle on which the part may be present. In still another example of an environment, the set of documents 104 may include a plurality of books, periodicals, articles, and other literary works that are present in an on-line, electronic reference library. The attributes associated with such items may include, but not be limited to, a title, an author's name, a publication date, a topic classification code, a Library of Congress number, and a copyright registration date.

In yet another example of an environment with which system 100 may be implemented, the set of documents 104 may comprise a store or vendor's catalog of products including a plurality of product descriptions or items having illustrative product pictures and/or textual information pertaining to the products. Attributes associated with such product descriptions or items may include, for example and not limitation, a product name, a product catalog or other identifying number, a price, size information, and color information.

From the examples of environments described above, it should be understood that the set of documents 104 (also sometimes referred to herein as a “document set 104”) might comprise any group, assembly, compilation, or library of materials or documents 102 in electronic data file form. It should also be understood that, as used herein, the term “document” might mean and refer to an electronic data file or data element including or representing, for example and without limitation, computer software, computer software technical documentation, computer software user documentation, a writing or printed paper, a spreadsheet, a three-dimensional model, a drawing, an illustration, a diagram, a chart, a manual, a book, a periodical, an article, a text, a poem, a short story, a novel, a thesis, a vendor's product or product description, or other information, material, work, or combination or portion thereof in text and/or graphics form.

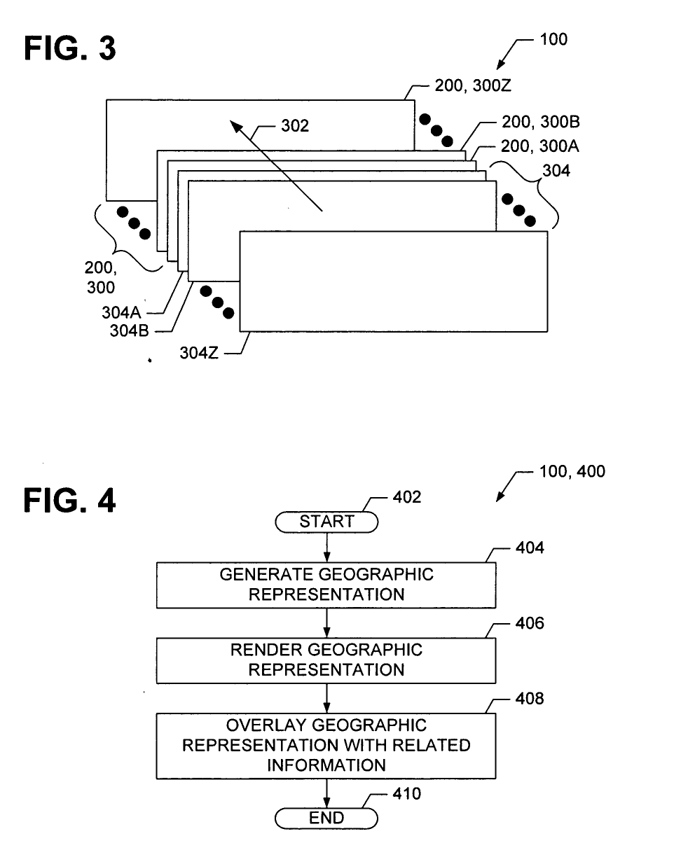

System 100, as illustrated in FIG. 1, may comprise a generator component 106, a rendering component 108, an overlay component 110, and a data component 112. The generator component 106 (or “generator software module 106”) includes a plurality of executable computer programming instructions. The generator component 106 is adapted, when executed, to retrieve attribute information associated with documents 102 of the set of documents 104 and to generate the geographic representation 200 (see FIG. 2) of such documents 102. The geographic representation 200 is described in more detail below with reference to FIG. 2, but generally comprises a virtual map of the set of documents 104 for display on a display device. The geographic representation 200 may have multiple display levels 300 (see FIG. 3) corresponding, respectively, to multiple levels of detail for the documents 102.

The generator component 106 may generate the geographic representation 200 on a static basis or on a dynamic basis. If generated on a static basis, the geographic representation 200 of the set of documents 104 is generated, perhaps, at pre-determined times, periodically at pre-determined intervals of time, or in response to user input. As a consequence, if changes are made to the documents 102 of the set of documents 104 after generation of the geographic representation 200, they are not reflected in the geographic representation 200 until the geographic representation 200 is re-generated. Thus, generation on a static basis may be acceptable only for sets of documents 104 that do not change frequently. Alternatively, if the geographic representation 200 is generated on a dynamic basis, the geographic representation 200 may be automatically generated, for example and not limitation, whenever a change is made to document 102 of the set of documents 104 or whenever rendering and display of the geographic representation 200 are to occur. As a result, the geographic representation 200 may be tailored at run-time to a specific scenario and/or user input, and accurately reflects the then current status of the documents 102 of the set of documents 104. Therefore, generation on a dynamic basis is useful for sets of documents 104 including documents 102 that change frequently.

Further, as described below in connection with various techniques and methods, the generator component 106 may optionally divide the geographic representation 200 after its generation into a plurality of logical portions 216 or tiles 216 (see FIG. 2). By doing so, the operational performance of the system 100 may be improved. Once the geographic representation 200 is produced with or without division into a plurality of logical portions 216, the generator component 106 stores the geographic representation 200 and its associated data in data component 112 as described in more detail below.

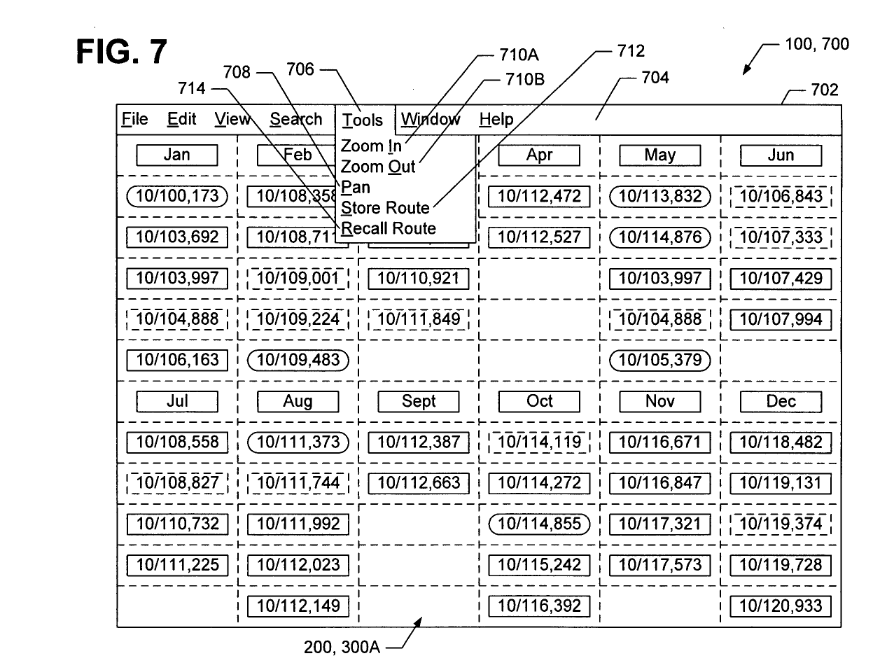

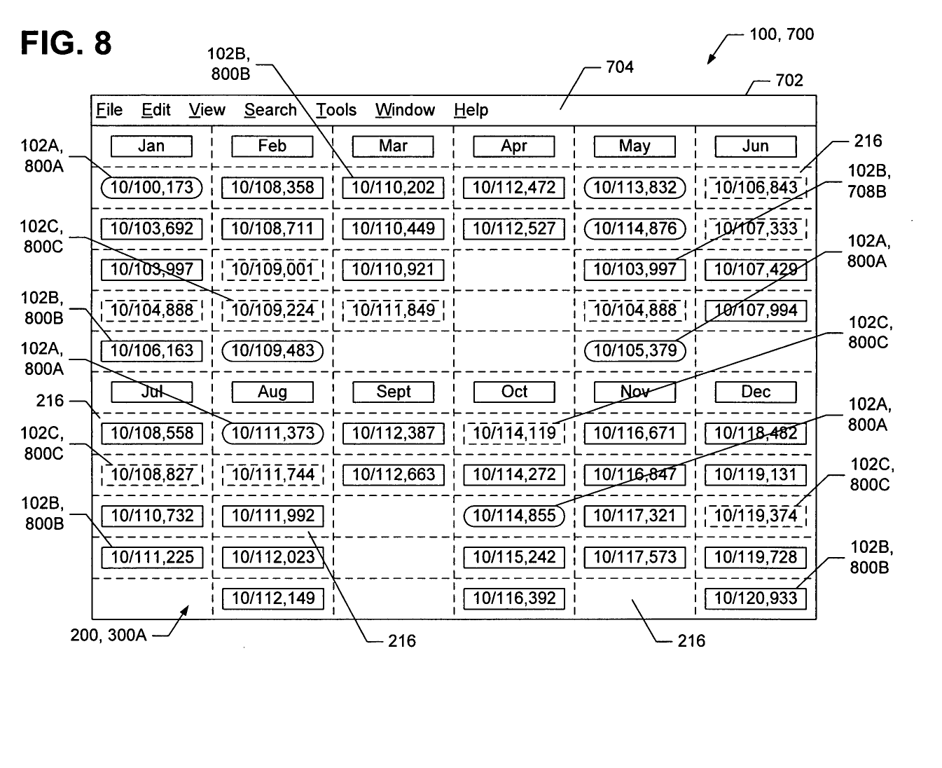

The rendering component 108 (or “rendering software module 108”) comprises a plurality of executable computer programming instructions that when executed, cause the rendering and display of the generated geographic representation 200 in a graphical user interface 700 (see FIGS. 7 and 8). The graphical user interface 700 may form part of, for example and not limitation, a web browser or application computer software program. The rendering component 108 may be hosted, for instance, in a web page or within a standalone application computer software program. More particularly, the rendering component 108 may include a map control framework into which the geographic representation 200 is loaded. The map control framework renders only a portion of the geographic representation 200 necessary to fill a display such as, for example, a window of a graphical user interface 700. Topographical elements and effects (including, without limitation, legends, symbols, line styles, and color coding) may be used by the rendering component 108 to represent documents 102 and to improve the readability and usability of the geographic representation 200.

An example map control framework may comprise a system, including programming and databases, similar to Microsoft's TerraServer™ image serving platform that can be utilized to store, render, and display aerial satellite images of the earth and other spatial data. In Microsoft's TerraServer™ image serving platform, image and spatial data is loaded into and stored on a server computer system as a plurality of tiles in a large multi-media database. The server computer system, via database management and other appropriate server software, serves image and spatial data requested by a user onto the Internet. The image and spatial data is served with a graphical user interface that may be hosted by any web browser that supports dynamic HTML pages, applets, and the display of JPEG or GIF images. As part of serving the image and spatial data, the server computer software fetches appropriate tiles from the database and mosaics them together as HTML web pages including image data in JPEG or GIF format to form a requested image. The server computer then communicates, to a user's web browser, an HTML table referencing the HTML web pages as a two dimensional array of tiles. The HTML table is used by the web browser in displaying the image and, when requested, the appropriate HTML web pages. The dynamic HTML pages and applets allow a user's web browser to communicate with the server computer system and the server software. Such communication includes the sending of a request for an image that a user desires to view and the receiving of the image, as described above, in JPEG or GIF format for display by the web browser. More detailed information on Microsoft's TerraServer™ image serving platform is available from Microsoft Corporation of Redmond, Wash.

The rendering component 108 may further comprise a plurality of sub-components 114 including a pan sub-component 114A and a zoom sub-component 114B. The pan sub-component 114A is configured to cause the rendering component 108 to render and display a different portion (e.g., via re-positioning of the display window 218 (see FIG. 2)) of the geographic representation 200 in the graphical user interface 700 (see FIGS. 7 and 8) in response to input from a user. The zoom sub-component 114B is adapted to render and display a different display level 300 (see FIG. 3) of the geographic representation 200 in the graphical user interface 700, thereby presenting a user with increased detail, information, and/or data related to documents 102 of the set of documents 104 upon zooming-in and less detail, information, and/or data related to documents 102 upon zooming-out. Thus, the granularity, fidelity, extent, depth, or amount of displayed detail, information, and/or data for a document 102 may be changed by a user zooming-in or zooming-out on the document 102. At minimum zoom, a topographical element representing a document 102 (and, perhaps, some basic identifying information or data for the document 102) might be visible to a user. At maximum zoom, the actual content of the document 102 may be visible to a user. At intermediate levels of zoom, varying degrees of information or data may be visible to a user, including, for example, attribute information associated with and/or pertaining to the document 102. Operation of the rendering component 108 is described more fully below with reference to various methods. In the example implementation utilizing the map control framework described above, the pan sub-component 114A and zoom sub-component 114B may be implemented via dynamic HTML pages and applets that allow the web browser to pan and zoom over an image.

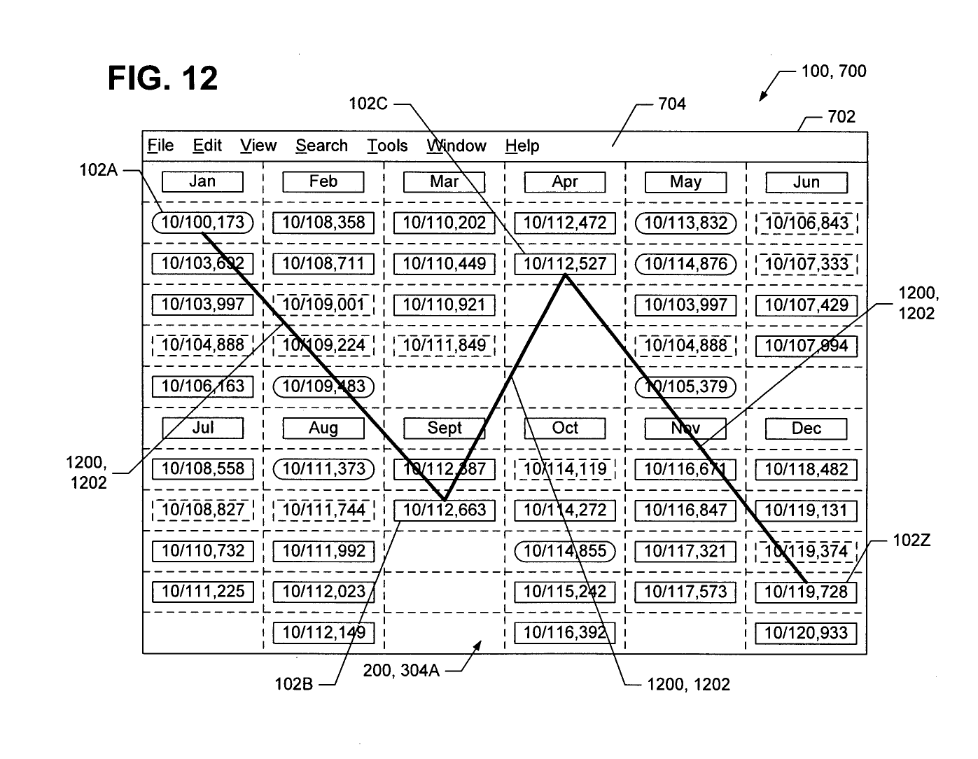

The overlay component 110 (or “overlay software module 110”) comprises a plurality of executable computer programming instructions that when executed, cause the display of information related to documents 102 represented by the geographic representation 200 in the graphical user interface 700 (see FIGS. 7 and 8). Generally, the related information is displayed, or overlaid, on top of a displayed portion of the geographic representation 200 (see FIG. 2) in one or more overlay layers 304 that are described more fully below with reference to FIG. 3. For example and not limitation, such related information may include a route 1200 (see FIG. 12) created between first and second documents 102A, 102Z (see FIG. 12). The route 1200 might include and identify other documents 102 that are related to the first and second documents 102A, 102Z and that might be of interest to a user and/or to other users. The route 1200 might define a suggested reading path and/or order for a user to use in reading the identified documents 102. Related information overlaid on top of a displayed portion of the geographic representation 200 might also include the identities of and references, or links, to other documents that are not part of the set of documents 104 corresponding to the geographic representation 200. These other documents may, instead, be part of or available from an external source 118 such as, but not limited to, another document set. Additionally, related information might include user comments or other user generated or provided information previously associated with documents 102.

The overlay component 110 may further comprise a plurality of sub-components 120 including a store route sub-component 120A and a recall route sub-component 120B. The store route sub-component 120A includes a plurality of computer programming instructions that are configured to cause the storing or saving of a created route and associated data in data component 112. Generally, storing of a created route occurs in response to input from a user, but may occur in response to other conditions or events. The recall route sub-component 120B includes a plurality of computer programming instructions that are adapted, upon execution, to cause the recall, or retrieval, of a previously created route and its associated data stored in data component 112. The recall route sub-component 120B is further adapted to cause the display, or overlay, of the recalled route on top of a displayed portion of the geographic representation 200 in one or more overlay layers 304 (see FIG. 3).

The data component 112 comprises information and/or data corresponding to the generated geographic representation 200 and any logical portions 216, or tiles 216, thereof (see FIG. 2) and to other information that is associated with the documents 102. Information and/or data corresponding to the generated geographic representation 200 typically includes, but is not limited to, information uniquely identifying each document 102, the assigned position of each document 102 within the geographic representation 200, and user generated or provided information or data related to the documents 102. Such information and/or data typically also includes, for example and not limitation, routes 1200 (see FIG. 12) created between documents 102, data identifying documents 102 located along and/or near the routes 1200, and names and/or other identifying information for the routes 1200. The names and/or other identifying information may be made available to or shared with other users so that the other users may initiate overlay of the routes 1200 on the geographic representation 200. Generally, data component 112 includes one or more database(s) and/or data file(s) that reside in a memory, on a data storage device, or media of a computing environment. Data corresponding to the generated geographic representation 200 is typically written to data component 112 by the generator component 106 and is retrieved by the rendering and overlay components 108, 110 during operation of the system 100. Data related to a route may be written to data component 112 and retrieved therefrom by the overlay component 110 during operation of the system 100.

The system 100 may optionally comprise an editing component 116 (or “editing software module 116”) that includes a plurality of executable computer programming instructions. When executed, the computer programming instructions enable the receipt of information and/or data related to an identified document 102 via user input. Execution of the computer programming instructions causes association of the received information and/or data with the document 102. The editing component 116 may also be configured to modify information and/or data previously received for and associated with a document 102. The information and/or data might include user comments or other user generated information that may be displayed by the overlay component 110 as described herein.

FIG. 2 displays a schematic view of an example of the geographic representation 200 of the set of documents 104. The geographic representation 200, as described briefly above, comprises a virtual map of the set of documents 104 for display on a display device. The geographic representation 200 is somewhat similar, in the abstract, to a geographic map of a portion of the world in which geographic features are rendered with topographical elements and/or effects. In the geographic representation 200, each document 102 of the set of documents 104 is assigned a unique, spatially located position relative to the other documents 102 of the set of documents 104 as described below. Then, when a portion of the geographic representation 200 is rendered and displayed on a display device as described more fully below, the documents 102 within such portion are represented at their respective spatially located positions by topographical elements, by attribute information, or by their actual content. The representation of the documents 102 used for their rendering depends on the desired level of detail to be displayed on the display device.

As illustrated in FIG. 2, the geographic representation 200 includes a global coordinate system 202. The global coordinate system 202 comprises a coordinate system relative to which each document 102 of the set of documents 104 is assigned a unique, spatially located position. The global coordinate system 202 has an x-axis 204, a y-axis 206, and an origin 208 located at the intersection of the x-axis 204 and y-axis 206. Thus, the assigned position of each document 102 may be expressed in terms of a global x-coordinate measured along x-axis 204 from origin 208 and a global y-coordinate measured along y-axis 206 from origin 208. Together, the global x-coordinate and the global y-coordinate for each document 102 define the assigned position of the document 102 within the geographic representation 200. The assigned position of each document 102 may also be expressed and defined by a global coordinate vector 210 as illustrated in FIG. 2 with respect to example documents 102A, 102B and through the use of the alphabetic letters “A” and “B” to designate elements related to the example documents 102A, 102B. Each global coordinate vector 210 has an associated global x-coordinate component 212 corresponding to the global x-coordinate measured along x-axis 204. Each global coordinate vector 210 also has an associated global y-coordinate component 214 corresponding to the global y-coordinate measured along y-axis 206. As alluded to above, the global coordinate vectors 210 are stored in data component 112 in connection with information or data uniquely identifying their respective documents 102 from all other documents 102 of the set of documents 104.

Optionally, and as briefly described above, the geographic representation 200 may be divided into a plurality of logical portions 216 (also sometimes referred to herein as “tiles 216”) to enhance the operating performance of the system 100 during use. In FIG. 2, such logical portions 216 have a generally rectangular shape, are bounded and identified by dashed lines, and are arranged in a row and column matrix. In the example implementation depicted in FIG. 2, there is a one-to-one correspondence between each logical portion 216 and each document 102 so that each logical portion 216 includes only one document 102. However, it should be understood that in most other example implementations, there might be no documents 102 or might be multiple documents 102 located within a logical portion 216 of the geographic representation 200. It should also be noted that in other example implementations, the logical portions 216 may not have a generally rectangular shape and, hence, documents 102 may not be arranged in a row and column matrix.

Typically, the entire geographical representation 200 of a set of documents 104 cannot be displayed on a display device with a high degree of readability. Therefore, only a portion of the geographical representation 200 is generally rendered and displayed on a display device at a particular time during use of the system 100. As illustrated in FIG. 2 with lines of greater line weight than the other lines, a display window 218 and corresponding display coordinate system 220 are positioned relative to the global coordinate system 202. The display window 218 corresponds to the portion of the geographic representation 200 that is rendered and displayed by the rendering component 108 in the graphical user interface 700 (see FIGS. 7 and 8) at a particular time during operation of the system 100. The display coordinate system 220 comprises a coordinate system local to and associated with the display window 218. The display coordinate system 220 has an x-axis 222, a y-axis 224, and an origin 226. Thus, the spatially located position of each document 102, as illustrated in FIG. 2 for respective example documents 102A, 102B, may also be expressed in terms of an x-coordinate measured along x-axis 222 from origin 226 and a y-coordinate measured along y-axis 224 from origin 226. These x-coordinates and y-coordinates together define the assigned position of each document 102 relative to the display window 218. The assigned position of each document 102 may also be defined relative to the display window 218 and the display coordinate system 220 by a display coordinate vector 228. Each display coordinate vector 228 has an associated display x-coordinate component 230 corresponding to the x-coordinate measured along x-axis 222 from origin 226. Each display coordinate vector 228 also has an associated display y-coordinate component 232 corresponding to the y-coordinate measured along y-axis 224 from origin 226.

A mapping vector 234 having an x-coordinate component 236 and a y-coordinate component 238 extends between the origin 208 of the global coordinate system 202 and the origin 226 of the display coordinate system 220. The mapping vector 234 defines the position of the display coordinate system 220 relative to the global coordinate system 202 and enables the mapping of coordinates therebetween. Using the mapping vector 234, information present in data component 112 identifying each document 102 and each document's assigned position (e.g., its global coordinate vector 210), and coordinate mapping techniques known to one of ordinary skill in the art, the identities of documents 102 selected by user input or other techniques may be determined.

It should be noted that although the display window 218 is illustrated in FIG. 2 with the boundaries of the display window 218 being substantially aligned with logical portions 216 for ease of illustration, there is no requirement that such alignment exist. More often than not, the display window boundaries are not aligned with the logical portions 216 during operation of the system 100.

The geographic representation 200 further comprises, as briefly described above, a plurality of display levels 300 (see FIG. 3) that correspond, respectively, to different levels of detail for the documents 102 and to different levels of magnification or zoom of the geographical representation 200. FIG. 3 displays a schematic view of an example of the geographic representation 200 showing a plurality of display levels 300 thereof. Each display level 300 (also sometimes referred to herein as a “display layer 300”) is denoted in FIG. 3 with an alphabetic letter “A” through “Z”. Ellipses are present in FIG. 3 to indicate that some of the possible display levels 300 are not shown so as to enhance the clarity of illustration. Increasing levels of magnification or zoom are indicted in FIG. 3 by the direction of arrow 302.

Notably, in FIG. 3, display level 300A corresponds to the lowest level of detail of the geographic representation 200 and to the lowest level of magnification or zoom. Therefore, display level 300A includes the least detailed information pertaining to each document 102. For example, display level 300A might include only a topographical symbol or legend for each document 102 and, perhaps, some basic information that identifies and distinguishes each document 102 relative to the other documents 102. Conversely, display level 300Z corresponds to the highest level of detail of the geographic representation 200 and to the highest level of magnification or zoom. Thus, display level 300Z includes the most detailed information related to each document 102. For instance, display level 300Z might include the actual content of each document 102 and all attribute data associated, respectively, with each document 102. Between display levels 300A, 300Z, other display levels 300 such as display level 300B correspond to intermediate levels of detail of the geographic representation 200 and to intermediate levels of magnification or zoom. Hence, display level 300B includes an intermediate level of information related to each document 102. For example, display level 300B might include attribute data corresponding to the attributes of the documents 102, but not the actual content of the documents 102.

The schematic view of FIG. 3 also illustrates that a plurality of overlay levels 304 may be produced and displayed by the overlay component 110 atop the display levels 300 of the geographic representation 200. Similar to the display levels 300, each overlay level 304 (also sometimes referred to herein as a “overlay layer 304”) is denoted in FIG. 3 with an alphabetic letter “A” through “Z” and ellipses indicate that some of the possible overlay levels 304 are not shown to render FIG. 3 more clear. Each overlay level 304 may include different types of information related to the documents 102 displayed on display levels 300 and may be displayed on the graphical user interface 700 (see FIGS. 7 and 8) concurrently with other overlay levels 304. For example, one overlay level 304A might include a route created between a first and second document 102, as noted above, that includes and identifies other documents 102 that are related to the first and second documents 102 and that might be of interest to a user. Another exemplary overlay level 304B might include the identities of and references, or links, to other documents of another document set 104 that might be of similar interest to a user. Still another exemplary overlay level 304Z might include user comments or other user generated or provided information previously associated with the documents 102 via the system's editing component 116.

FIG. 4 displays a flowchart view of an example of a method 400 for representing and presenting the set of documents 104 and related information to a user. After starting and performing appropriate initialization at step 402, the method 400 advances to step 404 where the generator component 106 produces the geographic representation 200 of the set of documents 104. The set of documents 104 may be identified to the generator component 106, for example, by a user of the system 100, by a computer software program, or by other technique. The generator component 106 then stores the geographic representation 200 (including any and all logical portions 216, or tiles 216, thereof) in the data component 112. Next, at step 406, the rendering component 108 retrieves the geographic representation 200 from the data component 112 and renders and/or displays one or more parts of the geographic representation 200 as will fit, for example, within the window 702 of the graphical user interface 700 (see FIGS. 7 and 8). The rendering component 108 may also render and/or display different parts of the geographic representation 200 or different display levels 300 thereof, respectively, upon invocation of the rendering component's pan and zoom functionality. Subsequently, at step 408 and generally in response to user input, the overlay component 110 retrieves or produces other information and/or data related to the documents 102 from data component 112 or from external sources 118. Then, such information and/or data is overlaid atop the geographic representation 200 in overlay layers 304 at appropriate locations relative to respective documents 102 and is displayed via the graphical user interface 700. Method 400 ends at step 410. Examples of methods corresponding generally to the generating, rendering, and overlaying steps 404, 406, 408 of method 400 are described below.

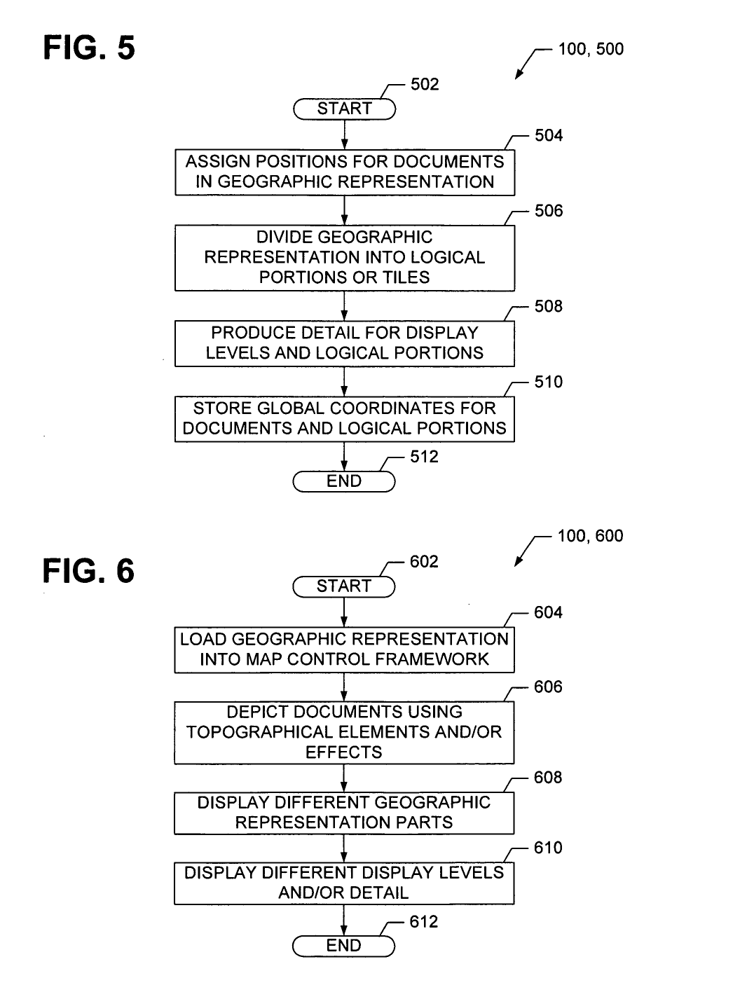

FIG. 5 displays a flowchart view of an example of a generating method 500 for generating, or producing, the geographic representation 200 of the set of documents 104 as briefly described above with respect to step 404 of method 400. Generally, generating method 500 is implemented by the generator component 106, but may be implemented by other components of the system 100. Generating method 500 begins at step 502 and advances to step 504 where individual documents 102 of the set of documents 104 are assigned positions within the geographic representation 200. The documents 102 may be positioned, for example and not limitation, in a row and column matrix as seen in the example geographic representation 200 of FIG. 2. Typically, the documents 102 are assigned positions based on one or more values of attributes associated with the documents 102, but positions may be assigned based on one or more other factors. For example, as depicted in FIGS. 7 and 8, a set of documents 104 including patent application and issued patent documents 102 might be assigned positions in the geographic representation 200 based on the month in which the documents 102 were filed with the United States Patent and Trademark Office. In another example, a set of documents 104 in an XML hierarchy might be assigned positions in the geographic representation 200 on the basis of their positions within the hierarchy. Regardless of the factors utilized for assigning a position for a document 102, a global coordinate vector 210 having a global x-coordinate component 212 and a global y-coordinate component 214 is associated with the document 102 once a position for the document 102 has been determined so that the document 102 can later be identified if selected by a user or other technique.

Next, at step 506, the geographic representation 200 may be divided into a plurality of logical portions 216, or tiles 216, to improve the rendering performance of the system 100. The logical portions 216 may have a generally rectangular or other shape. Each logical portion 216 of the geographic representation 200 may include none, one, or multiple documents 102 as appropriate. Continuing at step 508 of generating method 500, a plurality of display levels 300 are generated for the geographic representation 200 with respectively different levels of detail for each document 102 and/or logical portion 216. The different levels of detail correspond to different magnification or zoom levels. A user may selectively zoom in and zoom out on a particular document 102 in order to view a greater or lesser quantity of information and/or data about the document 102. Thus, for example, a display level 300A may be generated to include a minimal level of information, perhaps, including only basic identifying information for each document 102. Another display level 300Z may be generated to include a maximum level of information, perhaps, including the actual content of each document 102 and associated attributes. Still another display level 300B may be generated to include an intermediate level of detail including the values of attributes for each document 102, but no actual document content.

After producing the different display levels 300, generating method 500 proceeds to step 510 where the generated information and/or data for each document 102, logical portion 216, and display level 300 are stored in data component 112. Then, at step 512, generating method 500 ends.

FIG. 6 displays a flowchart view of an example of a rendering method 600 for rendering and displaying at least a portion of the geographic representation 200 generated for the set of documents 104. Typically, the rendering method 600 is implemented by the rendering component 108, but may be implemented by other system components. The rendering method 600 starts at step 602 and advances to step 604 where the generated geographic representation 200 for the set of documents 104 is generally loaded into a map control framework. If the geographic representation 200 has been previously divided into a plurality of logical portions 216, the geographic representation 200 is generally loaded into the map control framework in the form of the logical portions 216. Then, at step 606, the documents 102 corresponding to the logical portions 216 are depicted and displayed using appropriate topographical elements and/or effects (including, without limitation, text, titles, names, legends, symbols, icons, shapes, line styles, and/or colors) that are associated, for example, with particular values of attributes of the documents 102. Such use of topographical elements and/or effects may be described more clearly with reference to the graphical user interface 700 of FIGS. 7 and 8.

FIGS. 7 and 8 display pictorial views of an example of the graphical user interface 700 referred to herein for displaying at least a portion of the geographical representation 200 for the set of documents 104. The graphical user interface 700, as seen in FIGS. 7 and 8, has a window 702 in which at least a portion of the rendered geographical representation 200 is displayed. The graphical user interface 700 includes mechanisms and controls for facilitating and carrying out tasks such as, for example and not limitation, zooming in or out on the geographical representation 200, panning around the geographical representation 200, and storing or recalling a route (described in more detail below). As illustrated in FIG. 7, such mechanisms and controls include, but are not limited to, a menu bar 704 having a drop-down tool menu 706 with a pan option 708, a zoom in option 710A, a zoom out option 710B, a store route option 712, and a recall route option 714.

The documents 102 corresponding to the logical portions 216 are, as briefly described above, depicted and displayed using appropriate topographical elements and/or effects in FIGS. 7 and 8. Thus, documents 102 having a particular value of an attribute may be represented using a particular topographical element and/or effect and other documents 102 having a different value of the same attribute may be represented using a different topographical element and/or effect. By using topographical elements and/or effects in this way, documents 102 having a certain value of an attribute are visibly and readily distinguished from documents 102 having a different value of an attribute.

To illustrate the use of topographical elements and/or effects to readily distinguish documents 102, assume again that the set of documents 104 comprises patent application and/or issued patent documents 102. As seen in FIG. 8, patent application documents 102A that have been already published in the Official Gazette of the United States Patent and Trademark Office (e.g., their publication date attribute includes a date) are displayed as rounded rectangular shapes 800A. Patent application documents 102B that have not already been published (e.g., their publication date attribute does not include a date) are depicted as solid rectangular shapes 800B. Issued patent documents 102C (e.g., their issue date attribute includes a date) are displayed as dashed rectangular shapes 800C. As also illustrated in FIG. 8, attribute data such as, for instance, a serial number may be displayed within the topographical elements to aid a user in identifying and distinguishing between different documents 102. Additionally, it should be noted that the logical portions 216 of the geographic representation 200 may, but need not necessarily, be depicted using dashed lines to indicate their extent and boundaries. Further, it should be appreciated that while the set of documents 104 described herein and depicted in the figures for the purpose of illustration may include patent application and/or issued patent documents 102, the set of documents 104 may comprise other types of documents 102.

Referring back to FIG. 6 and proceeding to step 608, the rendering component 108 (and, more particularly, the pan sub-component 114A) may cause the rendering and display of different parts (e.g., different logical portions 216) of the geographic representation 200. Generally, such rendering and display occurs in response to a user selecting the pan option 708 from the drop-down tool menu 706 of menu bar 704 and moving a cursor within window 702. Responsive to movement of the cursor, the pan sub-component 114A moves the display window 218 and, hence, the origin 226 of the display coordinate system 220 relative to the origin 208 of the global coordinate system 202. The rendering component 108 then renders and displays the documents 102 presently within the display window 218 on the graphical user interface 700 using appropriate topographical elements and/or effects.

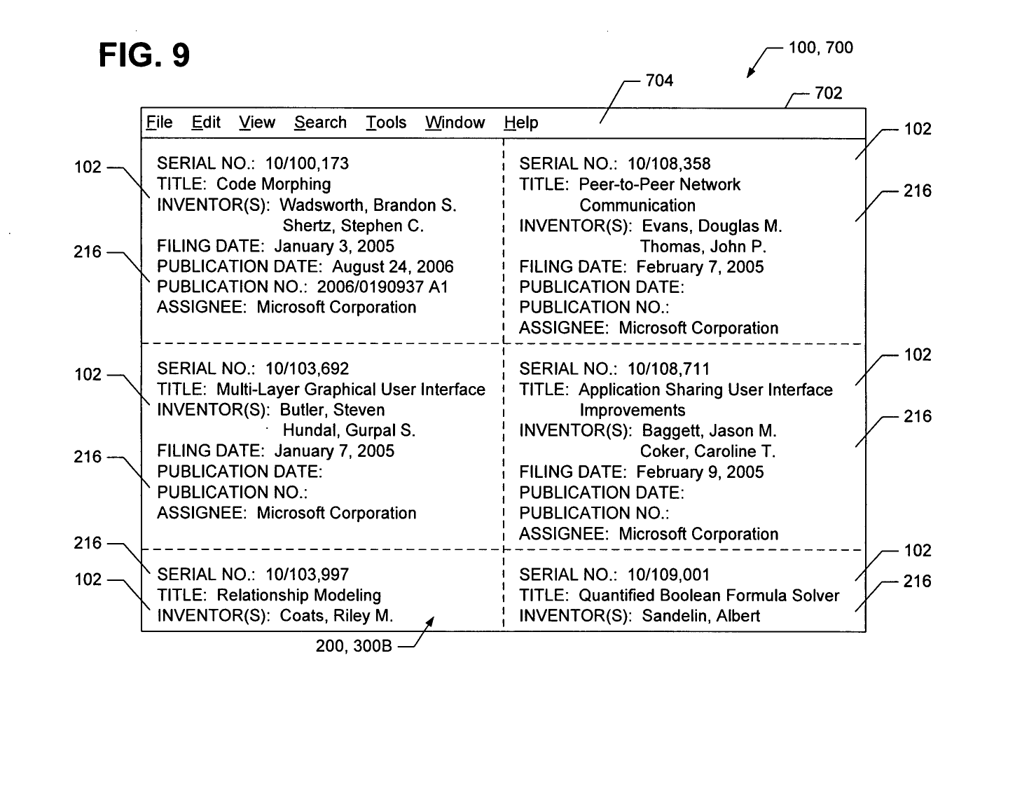

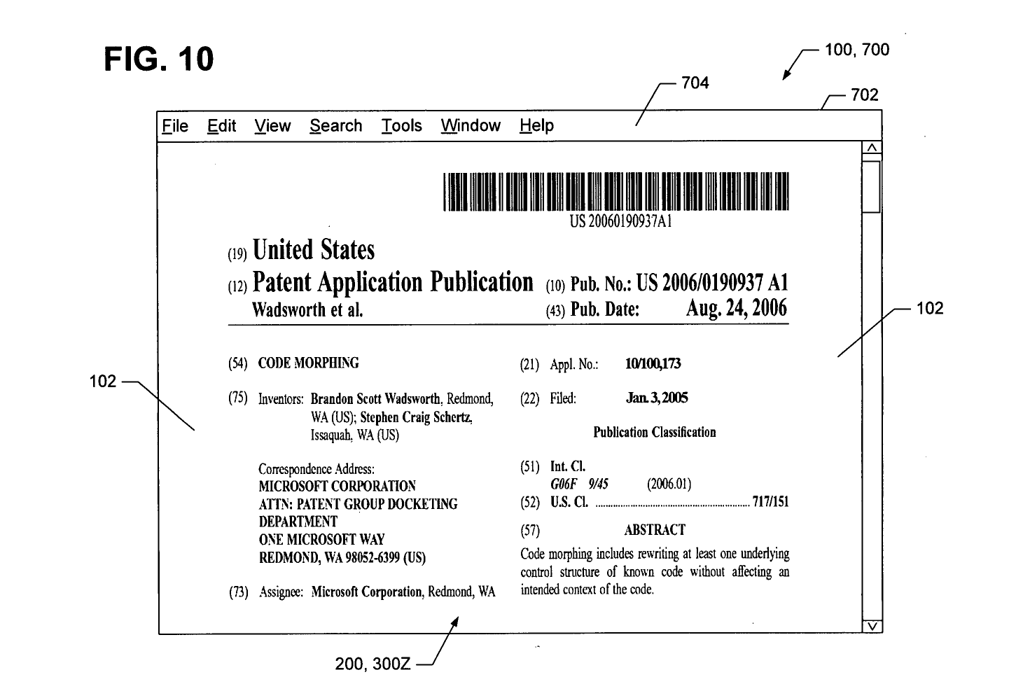

Then, at step 610 and in response to a user selecting a zoom option 710 from the drop-down tool menu 706 of menu bar 704, the rendering component 108 (and, more specifically, the zoom sub-component 114B) may cause the rendering and display of a different display level 300 of the geographic representation 200 on the graphical user interface 700. If display level 300A of the geographic representation 200 is being displayed to a user via graphical user interface 700 as illustrated in FIGS. 7 and 8 and the user selects the zoom in option 710A, the zoom sub-component 114B may cause the rendering and display of display level 300B. By displaying display level 300B, the user is provided with a greater level of detail for the documents 102. As the pictorial view of the graphical user interface 700 of FIG. 9 illustrates with respect to the set of patent application and/or issued patent documents 104, the rendering and display of display level 300B provides the user with attribute information associated with patent application and/or issued patent documents 102. Similarly, if display level 300B of the geographic representation 200 is being displayed to a user via graphical user interface 700 as shown in FIG. 9 and the user selects the zoom in option 710A, the zoom sub-component 114B may cause the rendering and display of display level 300Z. Through the display of display level 300Z, the user is provided with an even greater level of detail for the documents 102. As illustrated in FIG. 10 with regard to the set of patent application and/or issued patent documents 104, display level 300Z includes the actual content of a patent application document 102.

Alternatively, in response to the selection of the zoom out option 710B when the system 100 is currently displaying display level 300Z of the geographic representation 200, the zoom sub-component 114B may cause the rendering and display of display level 300B. By displaying display level 300B, the user is provided with a level of detail that is decreased as compared to that provided via display level 300Z. In response to the selection of the zoom out option 710B while display level 300B is being displayed on graphical user interface 700, the zoom sub-component 114B may cause the rendering and display of display level 300A. Through the display of display level 300A, the user is provided with a further decreased level of detail for the document 102. The rendering method 600 ends at step 612.

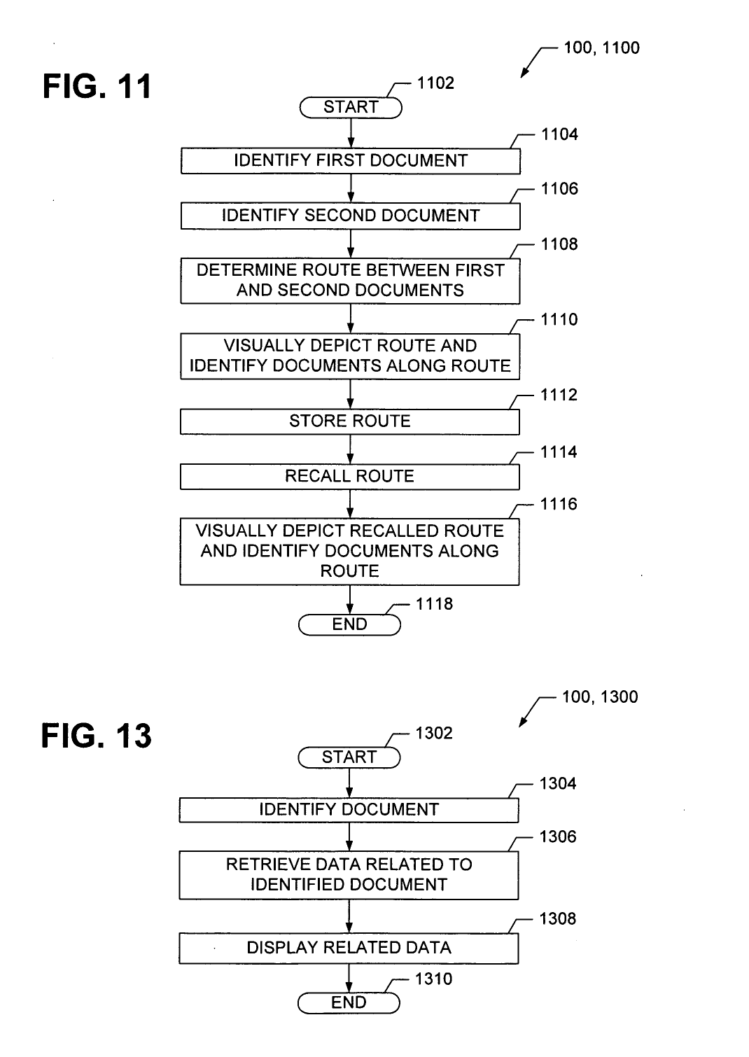

FIG. 11 displays a flowchart view of an example of an overlay method 1100 for overlaying and displaying information related to documents 102 of the geographic representation 200 in the graphical user interface 700. The overlay method 1100 is typically implemented by overlay component 110, but may be implemented by other system components. Generally, the related information is overlaid and displayed on top of a displayed portion of the geographic representation 200 in one or more overlay layers 304. More specifically, overlay method 1100 causes the overlay of a visual route, or path, between first and second documents 102 that identifies and includes other documents 102 that might be related to the first and second documents 102 in some manner. For example, other documents 102 along a particular route might relate to the first and second documents 102 of the route based at least on the value of a common attribute. In another example, other documents 102 along a route might relate to the first and second documents 102 of the route based on their relationship to a particular topic of interest to a user. A user may select documents 102 along a route to obtain more information.

After starting at step 1102, overlay method 1100 advances to step 1104 where a first document 102A of a route 1200 (see FIG. 12) is selected, for example and not limitation, by a user providing input via a pointing device of a computer system. Upon receiving such selection, the first document 102A is identified by mapping the display coordinate vector 228A (and its x-coordinate and y-coordinate components 230A, 232A) for the selected first document 102A to the global coordinate system 202 of the geographic representation 200. The resulting global coordinate vector 210A is then used in connection with information identifying each document 102 and the assigned position of each document 102 within the geographic representation 200 stored by data component 112 to identify the selected first document 102A.

Once the first document 102A is identified, overlay method 1100 moves to step 1106 where a second document 102Z of the route 1200 (see FIG. 12) is similarly selected, for example and not limitation, by a user providing input via a pointing device of a computer system. After such selection, the second document 102Z is identified using a technique similar to that described above for the first document 102A, but with a display coordinate vector 228Z for the selected second document 102Z.

Continuing, the route 1200 between the first and second documents 102A, 102Z is determined at step 1108 of overlay method 1100. As noted, the route 1200 might relate to the first and second documents 102A, 102Z based at least on the value(s) of a common attribute. To determine the route 1200 and to identify other documents 102 lying along the route 1200, a search query or other search tool may be created and used, for example, on the set of documents 104 corresponding to the geographic representation 200 to identify related documents 102. A search query or other search tool might also be created and used on other sets of documents 104 to identify related documents 102. Once other related documents 102 are identified, the route 1200 may be determined between the first and second documents 102A, 102Z. Generally, but not necessarily, the route 1200 begins at the first document 102A and ends at the second document 102Z, and passes through each of the related documents 102 intermediate the first and second documents 102A, 102Z. The route 1200 may be determined, for example, by retrieving a global coordinate vector 210 for each of the identified related documents 102 from data component 112 and mapping the retrieved global coordinate vector 210 into a display coordinate vector 228. The generated set of display coordinate vectors 228 correspond to the related documents 102 along the route 1200. The display coordinate vectors 228 may then be sorted or ordered according to particular criteria. For instance, the display coordinate vectors 228 may be ordered so that when a visual representation of the route 1200 is produced, the route 1200 will be easy to see and use. Alternatively, the display coordinate vectors 228 may be ordered in accordance with the degree of relevance that they may have to the first and second documents 102A, 102Z. Obviously, the display coordinate vectors 228 may be sorted or ordered in many different ways and according to many different criteria.

Next, at step 1110, display coordinate vectors 228A, 228Z for the first and second documents 102A, 102Z and the generated set of display coordinate vectors 228 for the related documents 102 are used to visually render and display the route 1200 on top of a displayed portion of the geographic representation 200 in one or more overlay layers 304. Many different topographical elements and/or effects may be utilized to render the route 1200 and to identify the documents 102 along the route 1200. The route 1200 may, for example, be rendered and displayed as a series of line segments that begin with the first document 102A, end with the second document 102Z, and interconnect related documents 102 therebetween. By interconnecting related documents 102, the interrelationship and, perhaps, the degree of relevance between the documents 102 are visually depicted. Documents 102 along the route 1200 may also be highlighted or be rendered using different topographical elements and/or effects to visually depict their interrelationship and/or degree of relevance.

Once a route 1200 has been rendered, overlay method 1100 may store, or save, the route 1200 in data component 112 at step 1112. Generally, storing of the route 1200 occurs in response to a user selecting a store route option 712 from the drop-down tool menu 706 of menu bar 704 (see FIG. 7) or in response to another technique for initiating storing of the route 1200. The route 1200 is stored by operation of overlay component 110 and, more specifically, by operation of the store route sub-component 120A. The store route sub-component 120A may store, or save, the route 1200 including, without limitation, the documents 102 located along and/or near the route 1200 and information associated with the documents 102. Typically, the route 1200 is stored in data component 112 using a route name, link, or other uniquely identifying information received from a user (perhaps, via a dialog box or other user interface) that may be provided to or shared with other users who may have an interest in subsequently recalling and viewing the route 1200. Documents 102 identified along the route 1200 and/or attribute information associated with such documents 102 may also be stored with the route 1200.

After a route 1200 has been rendered and stored, the route 1200 may be recalled for display from data component 112 and overlaid atop the geographic representation 200 of the set of documents 104 as illustrated by step 1114 of method 1100. Generally, the recall, or retrieval, and overlaying of a previously stored route 1200 occurs in response to a user selecting a recall route option 714 from the drop-down tool menu 706 of menu bar 704 (see FIG. 7), but may occur in response to other conditions or for other reasons. Upon such selection of the recall route option 714, the user is presented with an interface element that allows the user to input and/or select a previously stored route 1200 for viewing. The interface element may include, for example and not limitation, a text control for receiving a user entered name and/or a browsing interface to enable the user to browse through previously stored routes 1200 and to select a route 1200 for viewing. Regardless of how the system 100 receives a selection and/or identification of a previously-stored route 1200 for recall, method 1100 then visually renders and displays the recalled route 1200 on top of a displayed portion of the geographic representation 200 in one or more overlay layers 304 at step 1116 in a manner similar to that described above with respect to step 1110. After the route has been rendered and displayed, overlay method 1100 ends at step 1118.

FIG. 12 displays a pictorial view of an example of the route 1200 produced by method 1100 in connection with the geographic representation 200 of the example set of patent application and/or issued patent documents 104 employed herein for illustrative purposes. In FIG. 12, the route 1200 begins at first document 102A and ends at second document 102Z. The route 1200 is rendered as a series of line segments 1202 that extend between related documents 102 located at the ends of respective line segments 1202, thereby visually indicating their interrelationship and relevance to one another. For example, in FIG. 12, the documents 102 along route 1200 are related because the corresponding patent applications and/or issued patents have a common inventor (e.g., they have a common value for an associated attribute). If desired, however, other topographical elements and/or effects might be used to convey additional information about the patent application and/or issued patent documents 102 along the route 1200.

While information related to the documents 102 of the geographic representation 200 may be overlaid and displayed in the graphical user interface 700 according to overlay method 1100, information related to such documents 102 may also be overlaid and displayed using other methods. FIG. 13 displays a flowchart view of another example of an overlay method 1300 for overlaying and displaying information related to the documents 102 of the geographic representation 200 in the graphical user interface 700. Method 1300 is generally implemented by overlay component 110, but may be alternatively implemented by other components of a visual document user interface system 100. More particularly, method 1300 causes the overlay and display of information related to documents 102 that may be present in and available from data component 112, the corresponding set of documents 104, and/or other sources. Such other sources may include external sources 118 and may include, for example and not limitation, Internet websites, on-line databases, images, and other document sets 104.

After starting at step 1302, method 1300 advances to step 1304 where a document 102 is selected from the geographic representation 200. The document 102 may be selected, for example, by a user providing input via a pointing device of a computer system, by a computer system making an automated selection based on some criteria, or by another technique. The document 102 is identified by first mapping the document's display coordinate vector 228 (and its x-coordinate and y-coordinate components 230, 232) to the global coordinate system 202 of the geographic representation 200. The resulting global coordinate vector 210 is then used in connection with information identifying each document 102 and the assigned position of each document 102 within the geographic representation 200 stored by data component 112 to identify the selected document 102.

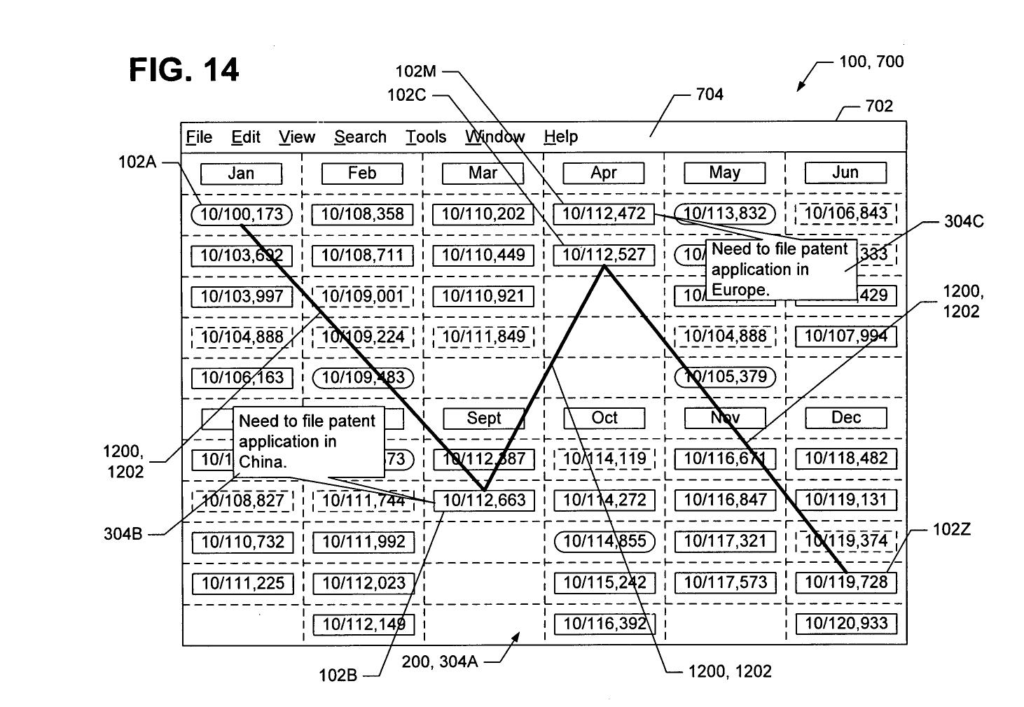

Notably and as illustrated in FIG. 14, the selected document 102 may include a document 102A, 102B, 102C, 102Z located along route 1200 or may include a document 102M that is not located along route 1200. FIG. 14 displays a pictorial view of the graphical user interface 700 with at least a portion of the geographic representation 200 of the example set of patent application and/or issued patent documents 104 displayed in window 702. A route 1200 has been overlaid atop the geographic representation 200 on overlay layer 304A by operation of method 1100 described above. The route 1200 extends between first and second documents 102A, 102Z and includes related intermediate documents 102B, 102C. It should be noted, however, that method 1300 might be used in connection with other geographic representations 200 onto which routes 1200 have not been overlaid.

Referring back to FIG. 13, method 1300 continues at step 1306 after a selected document 102 is identified. At step 1306, information and/or data is retrieved for the selected document 102. The retrieved information and/or data may be retrieved from data component 112, the corresponding set of documents 104, and/or other sources. Thus, the retrieved information and/or data may include, for example and not limitation, user comments and/or user produced or generated information previously input to data component 112 via operation of editing component 116, values of attributes associated with documents 102 of the set of documents 104, or information obtained through a search of other information sources. Generally, the retrieved information and/or data is related in some manner to the selected document 102.

Once related information and/or data have been retrieved for the selected document 102, method 1300 moves forward to step 1308 where the retrieved information and/or data is displayed via an overlay layer 304. Notably, the overlay layer 304 may comprise the same overlay layer 304A used to display route 1200 or may comprise a different overlay layer 304B. Further, as illustrated in FIG. 14, different overlay layers 304B, 304C may be used to display information and/or data of a different type or from different sources. Method 1300 then ends at step 1310.

The examples of systems, apparatuses, structures, techniques, and methods described above with reference to FIGS. 1-14 may be implemented in a computing or other environment having components that include, but are not limited to, one or more processors, system memory, a display device, and a system bus that couples various system components. Further, the computing or other environment may include a variety of computer readable media that are accessible by any of the various components, and includes both volatile and non-volatile media, removable and non-removable media.

Certain components and techniques herein may have been described in the general context of computer-executable instructions, such as software components or program components, executed by one or more computers or other devices. Generally, software components and program components include routines, programs, objects, components, and data structures for performing particular tasks or implementing particular abstract data types. Typically, the functionality of the software components and program components may be combined or distributed as desired in various implementations.

An implementation of these components and techniques may be stored on or transmitted across some form of computer readable media. Computer readable media can be any available media that can be accessed by a computer. By way of example, and not limitation, computer readable may comprise “computer storage media” and “communications media”.

“Computer storage media” includes volatile and non-volatile, removable and non-removable media implemented in any method or technology for storage of information such as computer readable instructions, data structures, program components, software components, or other data. Computer storage media includes, but is not limited to, random access memory (RAM), read only memory (ROM), electrically-erasable read only memory (EEPROM), flash memory or other memory technology, CD-ROM, digital versatile disk (DVD), or other optical storage, magnetic cassettes, magnetic tape, magnetic disk storage or other magnetic storage devices, or any other medium which can be used to store desired information and which can be accessed by a computer.

“Communication media” typically embodies computer readable instructions, data structures, program components, software components, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, radio frequency (RF), infrared (IR), and other wireless media. Combinations of any of the above are also included within the scope of computer readable media.

Reference may have been made herein to “an implementation”, an “exemplary implementation”, “an embodiment”, or an “exemplary embodiment” meaning that a particular described feature, structure, or characteristic is included in at least one implementation or embodiment of the present invention. Thus, usage of such phrases may refer to more than one implementation or embodiment. Furthermore, the described features, structures, or characteristics may be combined in any suitable manner in one or more implementation or embodiment.

One skilled in the relevant art may recognize, however, that the subject matter hereof may be practiced without one or more of the specific details, or with other structures, methods, resources, materials, or devices. In other instances, well known structures, resources, or operations have not been shown or described in detail herein merely to avoid obscuring aspects of the invention.

Although the subject matter hereof has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method in a computer system for displaying a set of documents having associated document attribute data, comprising the steps of:
generating a geographic representation of the set of documents for display on a display device, documents of the set of documents being assigned positions at respective locations within the geographic representation in accordance with associated document attribute data;
rendering at least a portion of the geographic representation on the display device; and
overlaying related information for the documents on the portion of the geographic representation rendered on the display device.

2. The method of claim 1, wherein the step of generating comprises a step of portioning the geographic representation into a plurality of geographic representation sub-portions adapted to improve rendering performance.

3. The method of claim 2, wherein the number of geographic representation sub-portions is based at least in part on the level of information detail to be rendered for each document.

4. The method of claim 1, wherein the step of generating is performed at the direction of a user.

5. The method of claim 1, wherein the step of generating is performed automatically.

6. The method of claim 1, wherein the geographic representation comprises one or more display levels for the set of documents that correspond respectively to one or more display magnification levels, the display levels further corresponding respectively to different levels of information detail for the documents of the set of documents.

7. The method of claim 6, wherein one display level includes the content of the documents of the set of documents.

8. The method of claim 1, wherein the geographic representation comprises one or more display levels for the set of documents, and the step of rendering comprises a step of displaying a display level of the geographic representation.

9. The method of claim 1, wherein the step of rendering comprises a step of depicting documents of the set of documents having different associated document attribute data with a different symbol.

10. The method of claim 1, wherein the step of rendering comprises a step of depicting documents of the set of documents having different associated document attribute data with a different color.

11. In a computer system having a graphical user interface including a display and a user interface input device, a method for displaying a set of documents and related information on the display, comprising the steps of:
producing a geographic representation of the set of documents based on global coordinates and having different levels of related information for display at different scales;
portioning the geographic representation into a plurality of tiles;
loading the plurality of tiles into a map control framework in order to cause the display of one or more of the plurality of tiles on the display; and
overlaying related information on top of the one or more tiles displayed on the display.

12. The method of claim 11, wherein the step of overlaying comprises the steps of identifying interrelated documents based at least on user input received via the user interface input device and the related information, and visually connecting the interrelated documents on the display.

13. The method of claim 12, wherein the step of visually connecting comprises a step of defining a document review path for a user to utilize in reviewing the interrelated documents.

14. The method of claim 11, wherein the step of overlaying comprises the steps of receiving user input via the user interface input device identifying a document and display coordinates, mapping the display coordinates to produce mapped global coordinates of the geographic representation, retrieving related information for the identified document based at least on the mapped global coordinates, and displaying the retrieved related information on the display.

15. The method of claim 14, wherein the step of retrieving related information comprises a step of accessing the related information from a source external to the set of documents.

16. The method of claim 14, wherein the related information comprises comments pertaining to a document.

17. The method of claim 14, wherein the related information comprises user-provided information pertaining to a document.

18. A computer-readable medium having computer-executable components for displaying a set of documents and related information on a display device, comprising:
a generation component for generating a geographic representation of a set of documents oriented according to attribute information associated with each document of the set of documents, the geographic representation including a plurality of levels comprising differing respective levels of information pertaining to the documents;
a rendering component for displaying at least a portion of the geographic representation of a particular level of information on a display device; and
an overlay component for overlaying the geographic representation with information related to one or more documents of the set of documents.

19. The computer-readable medium of claim 18, wherein the overlay component is further adapted to determine an interrelationship between multiple documents and to overlay the graphical representation with a route-like representation of the interrelationship.

20. The computer-readable medium of claim 18, wherein an interrelationship between multiple documents is identified via a query of the documents or the related information.
